(19) United States
(12) Patent Application Publication
(10) Pub. No.: US 2014/0039874 A1
(43) Pub. Date: Feb. 6, 2014

(54) Automatically Changing a Language for Electronic Messages

(71) Applicant: Alessandro Pelosi, San Francisco, CA (US)

(72) Inventor: Alessandro Pelosi, San Francisco, CA (US)

(73) Assignee: APPLE INC., Cupertino, CA (US)

(21) Appl. No.: 13/564,153

(22) Filed: Aug. 1, 2012

(51) Int. Cl. G06F 17/28

(52) U.S. Cl. 704/8

(57) ABSTRACT

Automatic language switching may use information obtained from a received message to select a proper language for creating an electronic message automatically, based on at least one of language information associated with the user, language information associated with the recipients, and language information extracted from a previously received message. A user may override the automatically selected language if desired. Information about what languages are known by the user may be inferred based on the language information extracted from a received message. Adaptive techniques may be used to limit or control which languages may be selected or offered for selection, based on previous user interactions.

### BACKGROUND

This disclosure relates generally to the field of electronic messaging. More particularly, but not by way of limitation, it relates to a technique for automatically choosing a language to use when sending a text message or email.

In a globally-connected world, electronic messages in the form of text or email may be sent and received in many different languages. Operating systems and messaging clients have begun to include support for multiple languages, but the user interface for switching between languages and adding a new language to the set of languages allowed or directly available to the user has typically required significant user intervention. Typically, a user must navigate through multiple levels of settings controls, sometimes requiring the user to leave the current application and return after making a language selection. Once the change in language has been made, reversion to a previous language does not happen automatically, but typically requires similar navigation through settings controls. All of this must be repeated any time the user wishes to change to a different language or add a new language.

In addition, language handling in operating systems and messaging clients is somewhat disconnected from the actual knowledge of languages by a user. A user fluent in (for example) Italian, but using a device initially configured for English may be unable to access Italian language features without explicitly indicating to the device that Italian is a known language, which may further diverge from the intended activity of the user that would involve use of Italian.

Because of the effort needed to switch between active languages and the effort required to add a new language to the set of known languages, users may decide not to make the switch to the other language, resulting in a less than optimal experience for one or both of the sender and recipient of the electronic message. For example, the user that is fluent in Italian may receive a message in Italian and prefer to respond in that language, knowing the recipient would prefer to communicate in Italian, but instead reply in English simply to avoid the effort of switching languages in the device. Better and more automatic handling of languages would improve user experiences and thus be desirable.

### SUMMARY

Automatic language switching may use information obtained from a received message to select a proper language for creating an electronic message automatically, based on at least one of language information associated with the user, language information associated with the recipients, and language information extracted from previously received messages. A user may override the automatically selected language if desired. Information about what languages are known by the user may be inferred based on the language information extracted from a received message or directly from the language used to write the current message analyzing the type and occurrence of actions from the auto-corrector. Adaptive techniques may be used to limit or control which languages may be selected or offered for selection, based on previous user interactions.

A non-transitory program storage device is disclosed. The program storage device is readable by a programmable control device. Instructions are stored on the program storage device for causing the programmable control device to identify a non-default language for use in writing an electronic communication from a sender to a recipient responsive to language information associated with other electronic communications or the recipient; and switch from a default language to the non-default language for writing the electronic communication.

A non-transitory program storage device is disclosed. The program storage device is readable by a programmable control device. Instructions are stored on the program storage device for causing the programmable control device to identify a non-default language for use in writing an electronic communication from a sender to a recipient responsive to language information associated with the recipient, including instructions for causing the programmable control device to identify a non-default language contained in an electronic communication from the recipient; determine whether the non-default language is associated with the sender; use the non-default language for writing the electronic communication if the non-default language is associated with the sender, including instructions for causing the programmable control to request approval from the sender to use the non-default language for writing the electronic communication; associate the non-default language with the recipient; switch from a default language to the non-default language for writing the electronic communication; and switch from the non-default language to the default language after completion of writing the electronic communication.

A programmable device is disclosed. The programmable device includes a programmable control device; and a memory coupled to the programmable control device, wherein instructions are stored in the memory, the instructions causing the programmable control device to identify a non-default language for use in writing an electronic communication from a sender to a recipient responsive to language information associated with another electronic communication from the recipient, including instructions for causing the programmable control device to identify a non-default language contained in the another electronic communication; and allow the non-default language to be selected for use in writing the electronic communication; use the non-default language for writing the electronic communication if the non-default language is associated with the sender, including instructions for causing the programmable control device to switch from a default language to the non-default language for writing the electronic communication; and switch from the non-default language to the default language after completion of writing the electronic communication.

A method is disclosed. The method includes the actions of identifying a non-default language for use in writing an electronic communication from a sender to a recipient, responsive to language information associated with the recipient or another electronic communication from the recipient; switching automatically from a default language to the non-default language for writing the electronic communication; and switching automatically from the non-default language to the default language after completion of writing the electronic communication.

### BRIEF DESCRIPTION OF THE DRAWINGS

FIG. 1 is a flowchart illustrating a technique for automatically switching to a non-default language when writing an electronic communication responsive to a language contained in another electronic communication.

FIG. 2 is a flowchart illustrating a technique for automatically switching to a non-default language when writing an electronic communication responsive to a language associated with a recipient of the electronic communication.

FIG. 3 is a block diagram illustrating a programmable device for implementing the techniques of FIGS. 1 and 2.

FIG. 4 is a block diagram illustrating a networked system for determining a language contained in an electronic communication.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following discussion, the term message should be understood as encompassing any form of electronic communication of textual information, including electronic mail (email) and Short Messaging Service (SMS) or other real-time messages (referred to herein as text messages).

The discussion below is written in terms of a smart phone, capable of sending and receiving messages, in addition to telephony functions. However, the description is not limited to smart phones, but encompasses any programmable device capable of sending and receiving messages, including desktop, laptop, and tablet computers.

Messaging clients as described below allow automatically selecting a language to use when replying to or writing a message. This automatic selection of a language may reduce the need for user intervention to set known languages, and may reduce the need to employ conventional techniques for setting an active language when answering or writing message. The language to use for a given message may be determined based upon language information associated with the user, including a history of interactions with the user or the history of interactions with other users related to language, as well as language information associated with the received message. As in conventional systems, the user may override the automatically selected language should the automatically selected language not be desirable for any reason.

For example, a user may normally communicate in English, but may also read and write Italian. The user may use a smart phone that is configured with English as a default language. When the user receives a message in Italian, the user may either answer in English or go to the trouble of switching the smart phone to Italian. Responding in English to an Italian message may be considered impolite or unfriendly, particularly if the recipient of the answer does not read or write English. But switching to Italian may involve more than navigating to settings to select a language. If the user has not previously identified to the smart phone that Italian is a known language, the smart phone may not offer Italian to the user as a possible language to select. Instead, the user would need to go to the trouble of adding Italian to the list of known languages. All of that is cumbersome, and take the user away from the desired task, which is to write a message in Italian.

Techniques described below can reduce the effort for a user to send messages in the recipient's preferred language. Replies to a message in the language are typically created in the language in which the message being replied to was written, but the user may override that if desired. The effort may further be reduced by observing how the user responds to suggestions about languages.

The techniques described below allow recognizing a likely desired language to use, including recognizing that the user may know the desired language, without diverging from the desired activity. In the situation described above, the smart phone may recognize that the received message was written Italian. On the assumption that the user would not receive a message in Italian if the user did not know Italian, the smart phone may automatically update the list of known languages to include Italian, without requiring user intervention. The smart phone may then select Italian for use in writing the reply to the received message, again without requiring any user intervention to select that language. When the user finishes with that message, the smart phone may automatically switch to English (or whatever language has been designated as a preferred or default language), instead of continuing in Italian. English and Italian are merely used illustratively and by way of example, and any languages may be employed using the techniques described below.

Scenario 1: Replying to a Message, Unknown Sender

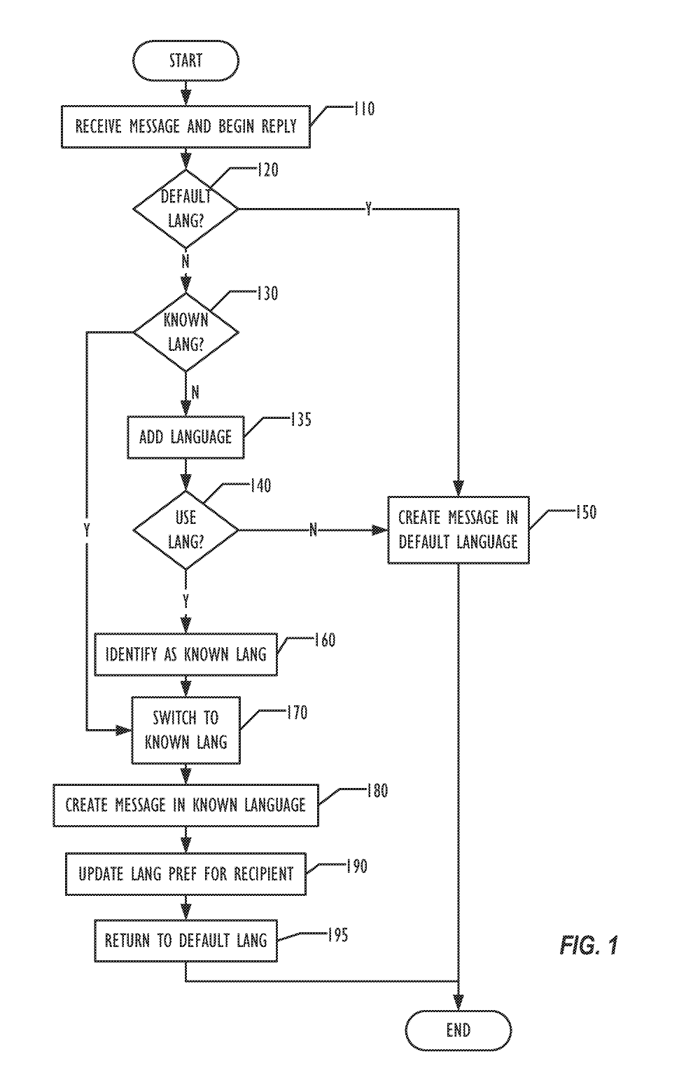

FIG. 1 is a flowchart illustrating a technique 100 for replying to a message in the proper language. In this scenario, the message being replied to was sent by someone not in the user's address book, although similar techniques may be used when the sender is known.

In block 110, a message is received by a messaging client on the user's device and a reply is begun by the user. The incoming message is then analyzed to determine the language in which it was written. There are numerous known techniques for making such a determination, including language trees, n-grams, and message attributes such as MIME (“Multipurpose Internet Mail Extensions”) types. Any desired technique or combination of techniques may be used for such a determination.

Determining the language a message is written in can be done on the user's device or in cloud. For example, Google Inc. has an API (“application programming interface”) for making the determination in the cloud, and there are many tools and libraries available from numerous sources that may be used. Some tuning of existing techniques may be used in situations where multiple languages are present in the text of a message being examined. As suggested above, the determination of the language of the message may be performed locally on the user's device or remotely, with the results of the determination returned to the local device. As one of skill will recognize, a message may be written in multiple languages, and implementations may use any desired criteria for selecting among the multiple languages for considering how to reply.

In block 120, if the language of the message is a default language for the user, then in block 150 the message may be created in the default language. However, if the language of the message is not the default language, then in block 130 a determination is made of whether the language is indicated as a known language of the user. Various techniques for indicating known languages may be used, including configuration settings for the device that store information about known languages. In some implementations, if a language is indicated as known, a language-specific keyboard may be available for entering text in that language.

If in block 130 the language is not already indicated as known, then in block 135 the language may be added as a known language, including adding any language-specific keyboard for entering text in that language. In block 140 the non-default language is selected for use, unless the user has previously rejected the choice globally or for the recipient of the message. Adaptive techniques may be used to determine a recipient or global threshold. Alternately, the user may be queried, using any user interface desired for making the query, whether the reply message should be created in the new language, requesting permission to use the new language. So for example, if the user did not list Italian as a known language, and the incoming message was determined to be written in Italian, then Italian may be added to the list of available languages and keyboards and selected for use in writing the message unless the user has previously rejected that choice. The user may be asked whether to continue writing the reply in Italian. If the user indicates the currently unknown language is not to be used, then in block 150 the reply message may be created using the default language. A user may choose to use the default language instead of a language in the incoming message for any reason, including because the user is not fluent in the language of the incoming message, or because the user simply prefers to use the default language at that time. In that situation, the configuration of the device does not need to change to allow the user to create the message.

If the user indicates that the new language is to be used, then in block 160 the new language may be identified as a known language of the user. In some implementations, identifying a new known language may require loading software modules related to that language, such as keyboard files, spelling dictionaries, and grammar rules, which may need to be obtained from a remote source of such information.

If the language was determined in block 130 as an already known language or was accepted by the user in block 140 as a new known language, then in block 170 the messaging client or software of the device may be switched to the known language for writing the message. This may involve loading information about the known language into memory, such as keyboard modules for interpreting keystrokes on a virtual or hardware keyboard, as well as spelling and grammar modules related to the known language.

The user may then enter text in the known language to create the message in block 180.

In block 190, some implementations may update an address book or other data to associate the known language as a preferred or known language of the sender of the message to which the reply is written. Any desired technique for associating the sender and the known language may be used.

Finally, after completing the creation of the message in the non-default known language, the device may be switched back to the default language. Thus the switch between languages happens automatically and without requiring the user to have to leave the messaging application to change languages or requiring the user to reset the current language of the device to the default language.

Scenario 2: Writing a Message, Known Single Recipient

In this scenario, a message is to be written to a single recipient. If the recipient is identified as having a preferred language, depending on the implementation the device may automatically select the preferred language or the default language and ask the user to validate the selection.

If the recipient doesn't have a preferred language the device may automatically select the default language and ask the user to validate the selection presenting alternate options including other languages known to the user. Upon selection of a non-default language the device may update the address book for the recipient.

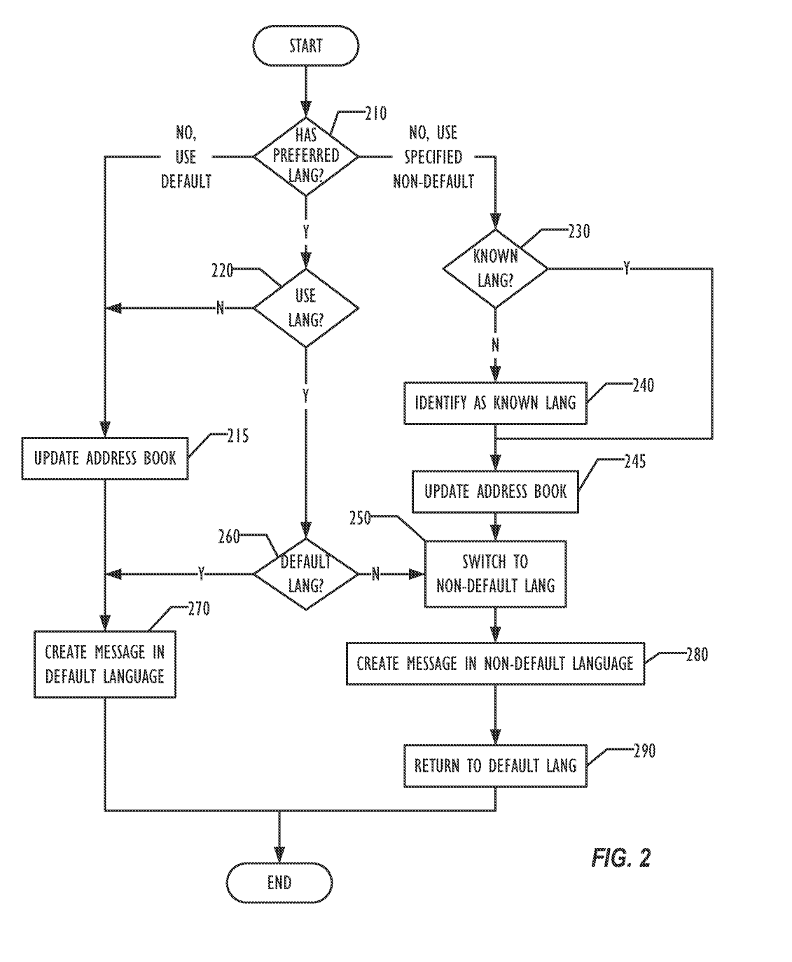

FIG. 2 illustrates a technique for performing this scenario. In block 210, a determination is made whether the recipient has an associated preferred language, such as may be indicated in an address book entry for that recipient. If no preferred language is indicated, the user may be offered an opportunity through a user interface to specify a language for writing the message. This may include displaying a list of languages identified as known languages of the user, but may also include an opportunity for the user to indicate a language not currently included in that list.

If the recipient has no preferred language, and the user chooses to use the default language for the message, in block 215 the recipient's address book entry may be updated to indicate that the default language is the preferred language for this recipient. Some implementations may omit this action, using the preferred language indication only for indicating a non-default language as a preferred language. Then, in block 270, the message may be created using the default language.

If the recipient has a preferred language, in block 220 the user may be offered a choice of using that preferred language or the default language for this message. Alternately, the user may be offered an opportunity to specify a non-default language as discussed below. If the user elects not to use the preferred language, then the recipient's address book entry may be updated to replace the preferred language with the default language in block 215, continuing to write the message in the default language in block 270. Other implementations may use adaptive techniques to decide whether to update the address book entry, so that a user may elect not to use the indicated preferred language from time to time without updating the preferred language indication, but if the user consistently refuses to use the indicated preferred language, eventually the preferred language may be updated in the address book. Some implementations may omit asking whether to use the preferred language in block 220 if the preferred language is the default language.

Some implementations may automatically select the indicated preferred language for use in writing the message, but allow a user to override that selection.

Although described herein as being indicated in the address book, the preferred language associated with a recipient may be maintained in any desired way, including keeping the preferred language indication external to the address book.

If the user accepts the use of the preferred language, in block 260 if the preferred language is the default language, then the message may be created in the default language without further language-related actions.

If, in block 210, the user specified a non-default language for use in writing the message, then in block 230 that non-default language is checked for being a known language of the user, such as by determining the presence or absence of keyboard information for that language. If the language is not known, then the language may be added, including adding keyboard information for the language and identified as a known language in block 240.

If the language is already known, or is added in block 240, then in block 245 the address book entry for the recipient may be updated to indicate the non-default language as the preferred language for that recipient. As in the discussion of block 215 above, adaptive techniques may be used to delay updating the address book unless the user habitually chooses that non-default language for communicating with the recipient, allowing writing messages in a non-preferred language occasionally without changing the preferred language indication.

In block 250, the device is switched to use the non-default language, such as providing a language specific keyboard and autocorrect information, then in block 280 the message may be created in the non-default language. After creation of the message, in block 290 the device may automatically revert to the default language.

Scenario 3: Messages with Multiple Recipients

In this scenario, a message is to be written to multiple recipients. In some implementations, if all of the multiple recipients the same known preferred language, then the device will be switched to use the common preferred language. If that language is not currently identified as known to the sender, then as described above, the user may be asked whether to use that language, and if the user confirms the use of that language, the language may be identified as a known language of the user.

Where not all of the multiple recipients are identified as having a common preferred language, implementations may simply use the default language, or may query the user whether to use the default language or one of the languages identified as preferred by a subset of the multiple recipients.

When replying to a message received by the user with multiple recipients, the language of the original message may be determined and, assuming that language is identified as known by the user, used to create the reply, temporarily switching away from the default language as described above in the discussion of FIGS. 1 and 2. If the language of the original message is not identified as known to the user, as described above, the user may be offered the opportunity to use that language (and enroll it as a known language) or to use the default language.

Adaptive Techniques

As described above, a user may be asked repeatedly whether to use a language not identified as known. This can become annoying. Implementations may enhance the techniques described above by using indirect feedback techniques that monitor language selection actions taken by the user when writing previous electronic communications. For example, a rejection threshold value may be defined so that if a user has been requested (and refused) permission to use a given language for more than the rejection threshold value, the messaging client will omit asking again, removing that language as a possible non-default language to use or not selecting it by default. Similarly, the messaging client may monitor responses from the user, to determine whether the user regularly overrides the preferred language when writing to one or more contacts. Such an override may occur by the user manually switching the device to the other language. If so, the messaging client may ask the user whether to change the preferred language for those contacts, or to remove the preferred language from the collection of known languages. Such an adaptive functionality may allow a user who does not know a language to stop being asked to use it. In another example, the functionality may allow a user who recently learned a language and wants to practice using that language to use the newly learned language when writing to the user's contacts, even though the user's contacts keep sending messages in the default or another language, without having to keep overriding the automatic selection of language made based on the language of the message and preferred languages of the other parties.

Implementation in a Programmable Device

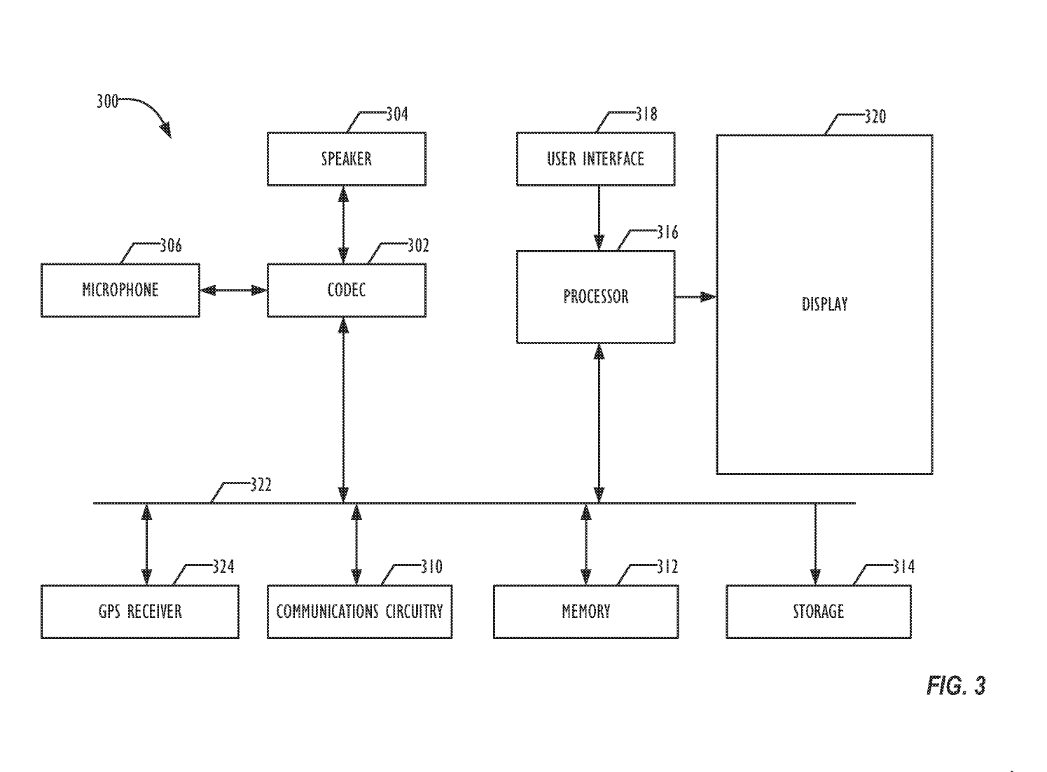

FIG. 3 is a simplified functional block diagram illustrating a programmable device 300 according to one embodiment that can implement the techniques described above. The programmable device 300 may include one or more processors 316, display 320, microphone 306, audio/video codecs 302, speaker 304, communications circuitry 310, an image sensor with associated camera hardware 308 for performing image capture, user interface 318, memory 312, storage device 314, and communications bus 322. Not all of these elements are required to be in every programmable device. For example, the programmable device 300 may exclude the camera hardware. Processor 316 may be any suitable programmable control device and may control the operation of many functions, such as the generation and/or processing of image data, as well as other functions performed by programmable device 300. Processor 316 may drive display 320 and may receive user inputs from the user interface 318. An embedded processor provides a versatile and robust programmable control device that may be utilized for carrying out the disclosed techniques.

Storage device 314 may store media (e.g., image and video files), software (e.g., for implementing various functions on device 300), preference information, device profile information, and any other suitable data. Storage device 314 may include one more storage mediums for tangibly recording image data and program instructions, including for example, a hard-drive, permanent memory such as ROM, semi-permanent memory such as RAM, or cache. Program instructions may comprise a software implementation encoded in any desired language (e.g., C or C++).

Memory 312 may include one or more different types of memory which may be used for performing device functions. For example, memory 312 may include cache, ROM, and/or RAM. Communications bus 322 may provide a data transfer path for transferring data to, from, or between at least storage device 314, memory 312, and processor 316. Although referred to as a bus, communications bus 322 is not limited to any specific data transfer technology. User interface 318 may allow a user to interact with the programmable device 300. For example, the user interface 318 can take a variety of forms, such as a button, keypad, dial, a click wheel, or a touch screen.

The programmable device 300 may a device such as such a mobile phone, personal data assistant (PDA), portable music player, monitor, television, laptop, desktop, and tablet computer, or other suitable personal device.

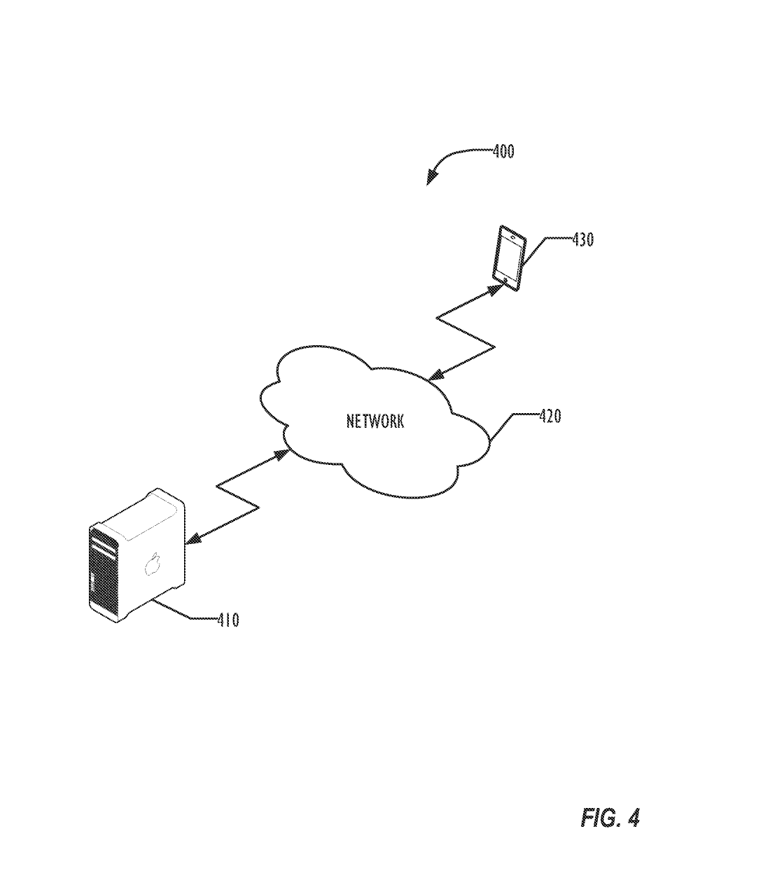

FIG. 4 is a block diagram illustrating a system 400 in which a personal programmable device 430, as illustrated a smart phone, uses functionality of a network connected other device 410, illustrated as a desktop computer for performing portions of the techniques described above. The personal programmable device 430 is connected to the other device 410 by one or more networks 420, which may be any type or types of networks.

For example, the computational resources of the device 410 may be used to process a message to determine the language of the text of the message, passing that language identification information on to the personal programmable device 430 for use in selecting what language to use for writing replies to the original message. In another example, the device 410 may store software modules related to language processing, so that when personal programmable device 430 is instructed to identify a language as known, the device 430 may request and obtain those modules from device 410. Such a system allows the programmable device 430 to store only those modules related to languages known to the user, reducing storage requirements on the device 410, and allowing for updated or additional language modules to be obtained from the device 410 as needed.

Although indicated above as a single processor 316, the techniques described above may be implemented using multiple processors 316, with

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A non-transitory program storage device, readable by a programmable control device, comprising instructions stored thereon for causing the programmable control device to:
identify a non-default language for use in writing an electronic communication from a sender to a recipient responsive to language information associated with other electronic communications or the recipient; and
switch from a default language to the non-default language for writing the electronic communication.

2. The program storage device of claim 1, wherein the instructions causing the programmable control device to identify a non-default language comprise instructions for causing the programmable control device to:
identify a non-default language associated with the recipient.

3. The program storage device of claim 1, wherein the instructions causing the programmable control device to identify a non-default language comprise instructions for causing the programmable control device to:
identify a non-default language contained in an electronic communication from the recipient.

4. The program storage device of claim 1, further comprising instructions stored thereon for causing the programmable control device to:
associate the non-default language with the recipient.

5. The program storage device of claim 1, wherein the instructions for causing the programmable control device to switch from the default language to the non-default language are executed only if the non-default language is a known language of the sender.

6. The program storage device of claim 1, wherein the instructions for causing the programmable control device to switch from the default language to the non-default language comprise instructions for causing the programmable control device to:
ask the sender whether to switch to the non-default language.

7. The program storage device of claim 1,
wherein the electronic communication is addressed to a plurality of recipients, and
wherein the instructions causing the programmable control device to identify a non-default language comprise instructions for causing the programmable control device to:
identify a non-default language associated with a sub-plurality of the plurality of recipients.

8. The program storage device of claim 1,
wherein the recipient is an addressee of a plurality of addressees of a first electronic communication received by the programmable control device, and
wherein the instructions causing the programmable control device to identify a non-default language comprise instructions for causing the programmable control device to:
identify a non-default language associated with a subplurality of the plurality of addressees.

9. The program storage device of claim 1, wherein the instructions stored thereon further comprise instruction for causing the programmable device to:
identify the non-default language as a known language of the sender.

10. The program storage device of claim 1,
wherein the recipient is an addressee of a plurality of addressees of a first electronic communication received by the programmable control device,
wherein the recipient is associated with the non-default language, and
wherein the instructions for causing the programmable control device to switch from a default language to the non-default language are not executed if the electronic communication is written as a reply to the first electronic communication.

11. The program storage device of claim 1, wherein the instructions for causing the programmable control device to switch from a default language to the non-default language are executed only if the non-default language is identified as a known language of the sender.

12. The program storage device of claim 1, wherein the instructions for causing the programmable control device to switch from a default language to the non-default language are executed only if the electronic communication is addressed to a single recipient or if any of a plurality of recipients of the electronic communication are associated with the non-default language.

13. The program storage device of claim 1, wherein the instructions stored thereon further comprise instructions for causing the programmable control device to:
disassociate the non-default language with the sender.

14. The program storage device of claim 1, wherein the instructions causing the programmable control device to identify a non-default language comprise instructions for causing the programmable control device to:
allow the sender to select the non-default language.

15. The program storage device of claim 1, wherein the instructions causing the programmable control device to identify a non-default language are executed remotely to the sender.

16. The program storage device of claim 1, wherein the instructions causing the programmable control device to identify a non-default language comprise instructions for causing the programmable control device to:
adjust a determination of the non-default language responsive to language selection actions performed by the sender when writing previous electronic communications.

17. The program storage device of claim 16, wherein the instructions causing the programmable control device to adjust a determination of the non-default language responsive to language selection actions performed by the sender when writing previous electronic communications comprise instructions for causing the programmable control device to:
remove a language as a possible non-default language responsive to switching from the language to another language when writing previous electronic communications.

18. A non-transitory program storage device, readable by a programmable control device, comprising instructions stored thereon for causing the programmable control device to:
identify a non-default language for use in writing an electronic communication from a sender to a recipient responsive to language information associated with the recipient, comprising instructions for causing the programmable control device to:
identify a non-default language contained in an electronic communication from the recipient;
determine whether the non-default language is associated with the sender;
use the non-default language for writing the electronic communication if the non-default language is associated with the sender, comprising instructions for causing the programmable control:
request approval from the sender to use the non-default language for writing the electronic communication;
associate the non-default language with the recipient;
switch from a default language to the non-default language for writing the electronic communication; and
switch from the non-default language to the default language after completion of writing the electronic communication.

19. The program storage device of claim 18, wherein the instructions for causing the programmable control device to use the non-default language for writing the electronic communication are executed only if the electronic communication is addressed to a single recipient or if any of a plurality of recipients of the electronic communication are associated with the non-default language.

20. The program storage device of claim 18, wherein the instructions stored on the program storage device further comprise instructions for causing the programmable control device to:
adjust a determination of the non-default language responsive to language selection actions performed by the sender when writing previous electronic communications.

21. A programmable device, comprising:
a programmable control device; and
a memory coupled to the programmable control device, wherein instructions are stored in the memory, the instructions causing the programmable control device to:
identify a non-default language for use in writing an electronic communication from a sender to a recipient responsive to language information associated with another electronic communication from the recipient, comprising instructions for causing the programmable control device to:
identify a non-default language contained in the another electronic communication; and
allow the non-default language to be selected for use in writing the electronic communication;
use the non-default language for writing the electronic communication if the non-default language is associated with the sender, comprising instructions for causing the programmable control to:
switch from a default language to the non-default language for writing the electronic communication; and
switch from the non-default language to the default language after completion of writing the electronic communication.

22. The programmable device of claim 21, wherein the instructions stored in the memory further comprise instructions for causing the programmable control device to:
request approval from the sender to use the non-default language.

23. The programmable device of claim 21, wherein the instructions stored in the memory further comprise instructions for causing the programmable control device to:
associate the non-default language with the recipient; and
associate the non-default language with the sender.

24. The programmable device of claim 21, wherein the instructions stored in the memory further comprise instructions for causing the programmable control device to:
adaptively remove the non-default language as a possible language for writing the electronic communication responsive to input received from the sender when writing previous electronic communications.

25. The programmable device of claim 21, wherein the instructions for causing the programmable control device to identify a non-default language contained in the another electronic communication comprise instructions for causing the programmable control device to:
receive an identification of the non-default language from another programmable device.

26. A method, comprising:
identifying a non-default language for use in writing an electronic communication from a sender to a recipient, responsive to language information associated with the recipient or another electronic communication from the recipient;
switching automatically from a default language to the non-default language for writing the electronic communication; and
switching automatically from the non-default language to the default language after completion of writing the electronic communication.

27. The method of claim 26, further comprising:
determining whether the non-default language is associated with the sender; and
performing the acts of switching automatically from a default language to the non-default language and switching automatically from the non-default language to the default language only if the non-default language is associated with the sender.

28. The method of claim 26, further comprising:
determining whether the non-default language is associated with the sender; and
associating the non-default language with the sender if the non-default language is not associated with the sender.

29. The method of claim 26, further comprising:
requesting permission to use the non-default language from the sender.

30. The method of claim 29, further comprising:
monitoring responses received from the sender responsive to requesting permission to use the non-default language; and
omitting the act of requesting permission to use the non-default language responsive to responses received from the sender refusing permission to use the non-default language.
